(19) United States
(12) Patent Application Publication
(10) Pub. No.: US 2022/0224850 A1
(43) Pub. Date: Jul. 14, 2022

(54) CAMERA MODULE

(71) Applicant: LG INNOTEK CO., LTD., Seoul (KR)

(72) Inventors: Eun Song KIM, Seoul (KR); Seok Hyun KIM, Seoul (KR); Kang Yeol PARK, Seoul (KR)

(73) Assignee: LG INNOTEK CO., LTD., Seoul (KR)

(21) Appl. No.: 17/609,143

(22) PCT Filed: May 8, 2020
(86) PCT No.: PCT/KR2020/006077

§ 371 Date: Nov. 5, 2021

(30) Foreign Application Priority Data
May 8, 2019 (KR) 10-2019-0053705

(51) Int. Cl. H04N 5/369; H04N 13/254; H04N 13/271; H04N 5/367

(52) U.S. Cl. CPC H04N 5/36965; H04N 5/367; H04N 13/271; H04N 13/254

(57) ABSTRACT

A camera module according to an exemplary embodiment of the present invention comprises: a light emitting unit which outputs an optical signal to an object; a light receiving unit which collects the optical signal output from the light emitting unit and reflected from the object; a sensor unit which, through a plurality of pixels, receives the optical signal received by the light receiving unit; and an image processing unit which, by means of the optical signal, processes information received through a first pixel having a valid value and a second pixel having an invalid value indicating pixel saturation, wherein at least one of a plurality of pixels adjacent to the second pixel includes the first pixel, and the image processing unit generates a valid value of the second pixel on the basis of the valid value of the first pixel among the plurality of pixels adjacent to the second pixel.

### TECHNICAL FIELD

Embodiment relate to a camera module.

### BACKGROUND ART

Three-dimensional (3D) content is being applied in many fields such as education, manufacturing, and autonomous driving fields as well as game and culture fields, and depth information (depth map) is required to acquire 3D content. Depth information is information that indicates a spatial distance and refers to perspective information of a point with respect to another point in a two-dimensional image.

As methods of acquiring depth information, a method of projecting infrared (IR) structured light onto an object, a method using a stereo camera, a time-of-flight (TOF) method, and the like are being used. According to the TOF method, a distance to an object is calculated by measuring a flight time, i.e., a time taken for light to be emitted and reflected. The greatest advantage of the ToF method is that distance information about a 3D space is quickly provided in real time. In addition, accurate distance information may be acquired without a user applying a separate algorithm or performing hardware correction. Furthermore, accurate depth information may be acquired even when a very close subject is measured or a moving subject is measured.

Accordingly, there is an attempt to use the TOF method for biometric authentication. For example, it is known that a shape of a vein spread into a finger or like does not change throughout life from when a person is a fetus and varies from person to person. Accordingly, a vein pattern may be identified using a camera device having a TOF function. To this end, after fingers are photographed, each finger may be detected by removing a background based on the color and shape of the finger, and a vein pattern of each finger may be extracted from color information of the detected each finger. That is, an average color of the finger, a color of veins distributed in the finger, and a color of wrinkles in the finger may be different from each other. For example, the color of the veins distributed in the finger may have a red color lighter than that of the average color of the finger, and the color of the wrinkles in the finger may be darker than the average color of the finger. By using such features, a value approximating to a vein for each pixel can be calculated, and a vein pattern can be extracted using the calculated result. An individual can be identified by comparing an extracted vein pattern of each finger with pre-registered data.

As an intensity of light output from a light-emitting unit becomes stronger, a ToF camera module may accurately measure the shape or distance of an object disposed at a long distance. However, when an intensity of light is set to be strong in order to measure an object disposed at a long distance, pixels of an image sensor may be saturated. In addition, even though an intensity of light is not strong, when light is irradiated onto a portion of an object which has high reflectivity, an intensity of reflected light is strong, and thus the pixels of the image sensor may be saturated. The pixels saturated as described above are regarded as dead pixels during image processing, and thus, a null value is set. Accordingly, an empty space is generated in the saturated pixel, which causes the degradation of image quality.

### DISCLOSURE

### Technical Problem

The present invention is directed to providing a camera module configured to generate a high-quality image.

### Technical Solution

According to an exemplary embodiment of the present invention, a camera module includes a light-emitting unit configured to output an optical signal to an object, a light-receiving unit configured to receive the optical signal that is output from the light-emitting unit and reflected from the object, a sensor unit configured to receive the optical signal received by the light-receiving unit through a plurality of pixels, and an image processing unit configured to process information, which is received through first pixels having valid values and second pixels having invalid values, using the optical signal, wherein the invalid value is a value in which the pixel is saturated, wherein at least one of the plurality of pixels adjacent to the second pixel includes the first pixel, and the image processing unit generates a valid value of the second pixel based on the valid value of the first pixel among the plurality of pixels adjacent to the second pixel.

When all of the pixels adjacent to the second pixel are the first pixels, the image processing unit may generate the valid value of the second pixel based on the valid values of all of the first pixels adjacent to the second pixel.

When there are five first pixels adjacent to the second pixel, the image processing unit may generate the valid value of the second pixel based on the valid values of three first pixels among the five first pixels.

Among the five first pixels, the three first pixels may include two first pixels adjacent to one surface of the second pixel and one first pixel disposed between the two first pixels adjacent to the one surface of the second pixel.

When there are three first pixels adjacent to the second pixel, the image processing unit may generate the valid value of the second pixel based on the valid values of the three first pixels.

The image processing unit may generate the valid value of the second pixel by performing an interpolation technique, an average technique, or a Gaussian profile technique on at least one of the valid values of the first pixels adjacent to the second pixel.

An image may further include third pixels having invalid values, wherein all of the pixels adjacent to the third pixel have invalid values.

When a valid value of at least one pixel among the pixels adjacent to the third pixel is generated, the image processing unit may generate a valid value of the third pixel based on the generated valid value of the pixel adjacent to the third pixel.

The image processing unit may generate the valid value of the third pixel based on the valid values of all of the second pixels adjacent to the third pixel.

The image processing unit may generate the valid value of the third pixel by applying at least one of an interpolation technique, an average technique, and a Gaussian profile technique.

### Advantageous Effects

According to one exemplary embodiment of the present invention, an image is corrected by generating a dead pixel value that occurs due to light saturation or noise, thereby improving the quality of the image.

### DESCRIPTION OF DRAWINGS

FIG. 1 is a block diagram of a camera module according to an exemplary embodiment of the present invention.

FIG. 2 is a block diagram of a light-emitting unit according to an exemplary embodiment of the present invention.

FIG. 3 is a diagram for describing a light-receiving unit according to an exemplary embodiment of the present invention.

FIG. 4 shows diagrams for describing a sensor unit according to an exemplary embodiment of the present invention.

FIG. 5 is a diagram for describing a process of generating an electrical signal according to an exemplary embodiment of the present invention.

FIG. 6 is a diagram for describing a sub-frame image according to an exemplary embodiment of the present invention.

FIG. 7 is a diagram for describing a depth image according to an exemplary embodiment of the present invention.

FIG. 8 is a diagram for describing a time-of-flight (ToF) infrared (IR) image according to an exemplary embodiment of the present invention.

FIG. 9 shows diagrams for describing a first exemplary embodiment of the present invention.

FIG. 10 shows diagrams for describing a second exemplary embodiment of the present invention.

FIG. 11 shows diagrams illustrating one exemplary embodiment of the present invention.

FIG. 12 shows diagrams for describing a third exemplary embodiment of the present invention.

FIG. 13 shows diagrams illustrating one exemplary embodiment of the present invention.

### MODES OF THE INVENTION

Hereinafter, exemplary embodiments of the present invention will be described in detail with reference to the accompanying drawings.

However, the technical spirit of the present invention is not limited to some exemplary embodiments disclosed below but can be implemented in various different forms. Without departing from the technical spirit of the present invention, one or more of components may be selectively combined and substituted to be used between the exemplary embodiments.

Also, unless defined otherwise, terms (including technical and scientific terms) used herein may be interpreted as having the same meaning as commonly understood by one of ordinary skill in the art to which the present invention belongs. General terms like those defined in a dictionary may be interpreted in consideration of the contextual meaning of the related technology.

Furthermore, the terms used herein are intended to illustrate exemplary embodiments but are not intended to limit the present invention.

In the present specification, the terms expressed in the singular form may include the plural form unless otherwise specified. When “at least one (or one or more) of A, B, and C” is expressed, it may include one or more of all possible combinations of A, B, and C.

In addition, terms such as “first,” “second,” “A,” “B,” “(a),” and “(b)” may be used herein to describe components of the exemplary embodiments of the present invention.

Each of the terms is not used to define an essence, order, or sequence of a corresponding component but used merely to distinguish the corresponding component from other components.

In a case in which one component is described as being “connected,” “coupled,” or “joined” to another component, such a description may include both a case in which one component is “connected,” “coupled,” and “joined” directly to another component and a case in which one component is “connected,” “coupled,” and “joined” to another component with still another component disposed between one component and another component.

In addition, in a case in which any one component is described as being formed or disposed “on (or under)” another component, such a description includes both a case in which the two components are formed to be in direct contact with each other and a case in which the two components are in indirect contact with each other such that one or more other components are interposed between the two components. In addition, in a case in which one component is described as being formed “on (or under)” another component, such a description may include a case in which the one component is formed at an upper side or a lower side with respect to another component.

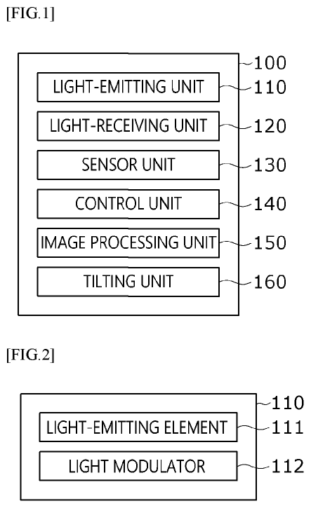

FIG. 1 is a block diagram of a camera module according to an exemplary embodiment of the present invention.

A camera module 100 according to the exemplary embodiment of the present invention may be referred to as a camera device, a time-of-flight (ToF) camera module, a ToF camera device, or the like.

The camera module 100 according to the exemplary embodiment of the present invention may be included in an optical device. The optical device may include any one of a cellular phone, a mobile phone, a smartphone, a portable smart device, a digital camera, a laptop computer, a digital broadcasting terminal, a personal digital assistant (PDA), a portable multimedia player (PMP), and a navigation device. However, types of the optical device are not limited thereto, and any device for capturing an image or video may be included in the optical device.

Referring to FIG. 1, the camera module 100 according to the exemplary embodiment of the present invention may include a light-emitting unit 110, a light-receiving unit 120, a sensor unit 130, and a control unit 140 and may further include an image processing unit 150 and a tilting unit 160.

The light-emitting unit 110 may be a light-emitting module, a light-emitting unit, a light-emitting assembly, or a light-emitting device. The light-emitting unit 110 may generate and output an optical signal, that is, irradiate the generated optical signal to an object. In this case, the light-emitting unit 110 may generate and output the optical signal in the form of a pulse wave or a continuous wave. The continuous wave may be in the form of a sinusoid wave or a squared wave. In the present specification, the optical signal output by the light-emitting unit 110 may refer to an optical signal incident on an object. The optical signal output by the light-emitting unit 110 may be referred to as output light, an output light signal, or the like with respect to the camera module 100. Light output by the light-emitting unit 110 may be referred to as incident light, an incident light signal, or the like with respect to an object.

The light-emitting unit 110 may output, that is, irradiate, light to an object during a predetermined exposure period (integration time). Here, the exposure period may refer to one frame period, that is, one image frame period. When a plurality of frames are generated, a set exposure period is repeated. For example, when the camera module 100 photographs an object at 20 frames per second (FPS), an exposure period is 1/20 [sec]. When 100 frames are generated, an exposure period may be repeated 100 times.

The light-emitting unit 110 may output a plurality of optical signals having different frequencies. The light-emitting unit 110 may sequentially and repeatedly output a plurality of optical signals having different frequencies. Alternatively, the light-emitting unit 110 may simultaneously output a plurality of optical signals having different frequencies.

The light-emitting unit 110 may set a duty ratio of an optical signal within a preset range. According to an exemplary embodiment of the present invention, a duty ratio of an optical signal output by the light-emitting unit 110 may be set within a range that is greater than 0% and less than 25%. For example, a duty ratio of an optical signal may be set to 10% or 20%. A duty ratio of an optical signal may be preset or may be set by the control unit 140.

The light-receiving unit 120 may be a light-receiving module, a light-receiving unit, a light-receiving assembly, or a light-receiving device. The light-receiving unit 120 may receive an optical signal that is output from the light-emitting unit 110 and reflected from an object. The light-receiving unit 120 may be disposed side by side with the light-emitting unit 110. The light-receiving unit 120 may be disposed adjacent to the light-emitting unit 110. The light-receiving unit 120 may be disposed in the same direction as the light-emitting unit 110. The light-receiving unit 120 may include a filter for allowing an optical signal reflected from an object to pass therethrough.

In the present specification, an optical signal received by the light-receiving unit 120 may refer to an optical signal reflected from an object after the optical signal output from the light-emitting unit 110 reaches the object. The optical signal received by the light-receiving unit 120 may be referred to as input light, an input light signal, or the like with respect to the camera module 100. Light output by the light-receiving unit 120 may be referred to as reflected light, a reflected light signal, or the like from an object.

The sensor unit 130 may sense the optical signal received by the light-receiving unit 120. The sensor unit 130 may receive the optical signal received by the light-receiving unit through a plurality of pixels. The sensor unit 130 may be an image sensor which senses an optical signal. The sensor unit 130 may be used interchangeably with a sensor, an image sensor, an image sensor unit, a ToF sensor, a ToF image sensor, and a ToF image sensor unit.

The sensor unit 130 may generate an electrical signal by detecting light. That is, the sensor unit 130 may generate an electrical signal through the optical signal received by the light-receiving unit 120. The generated electrical signal may be an analog type. The sensor unit 130 may generate an image signal based on the generated electrical signal and may transmit the generated image signal to the image processing unit 150. In this case, the image signal may be an electrical signal which is an analog type or a signal obtained by digitally converting an electrical signal into an analog type. When an electrical signal which is an analog type is transmitted as an image signal, the image processing unit 150 may digitally convert the electrical signal through a device such as an analog-to-digital converter (ADC).

The sensor unit 130 may detect light having a wavelength corresponding to a wavelength of light output from the light-emitting unit 110. For example, the sensor unit 130 may detect infrared light. Alternatively, the sensor unit 130 may detect visible light.

The sensor unit 130 may be a complementary metal oxide semiconductor (CMOS) image sensor or a charge coupled device (CCD) image sensor. In addition, the sensor unit 130 may include a ToF sensor which receives an infrared optical signal reflected from a subject and then measures a distance using a time difference or a phase difference.

The control unit 140 may control each component included in the camera module 100.

According to an exemplary embodiment of the present invention, the control unit 140 may control at least one of the light-emitting unit 110 and the sensor unit 130. In addition, the control unit 140 may control a sensing period of the sensor unit 130 with respect to an optical signal received by the light-receiving unit 120 in association with an exposure period of the light-emitting unit 110.

In addition, the control unit 140 may control the tilting unit 160. For example, the control unit 140 may control the tilt driving of the tilting unit 160 according to a predetermined rule.

The image processing unit 150 may receive an image signal from the sensor unit 130 and process the image signal (for example, perform digital conversion, interpolation, or frame synthesis thereon) to generate an image.

The image processing unit 150 may generate an image based on an image signal. In this case, the image may include a first pixel having a valid value and a second pixel having an invalid value that is a value at which a pixel is saturated. In this case, the invalid value may be a null value. That is, the image processing unit 150 may process information, which is received through the first pixel having a valid value and the second pixel having an invalid value, using an optical signal. At least one of a plurality of pixels adjacent to the second pixel may include the first pixel. In addition, the image may further include a third pixel. The third pixel may have an invalid value, and all pixels adjacent thereto may have an invalid value.

The image processing unit 150 may generate a valid value of the second pixel using a valid value of the first pixel. When a valid value of at least one pixel of the pixels adjacent to the third pixel is generated, the image processing unit 150 may generate a valid value of the third pixel based on the generated valid value of the pixel adjacent to the third pixel. The image processing unit 150 may use at least one of an interpolation technique, an average technique, and a Gaussian profile technique to generate valid values of the second pixel and the third pixel of which a pixel value is a null value, that is, an invalid value.

According to one exemplary embodiment, the image processing unit 150 may synthesize one frame (having high resolution) using a plurality of frames having low resolution. That is, the image processing unit 150 may synthesize a plurality of image frames corresponding to an image signal received from the sensor unit 130 and generate a synthetic result as a synthetic image. The synthetic image generated by the image processing unit 150 may have resolution that is higher than that of the plurality of image frames corresponding to the image signal. That is, the image processing unit 150 may generate a high resolution image through a super resolution (SR) technique.

The image processing unit 150 may include a processor which processes an image signal to generate an image. The processor may be implemented as a plurality of processors according to functions of the image processing unit 150, and some of the plurality of processors may be implemented in combination with the sensor unit 130. For example, a processor which converts an electrical signal which is an analog type into an image signal which is a digital type may be implemented in combination with a sensor. As another example, the plurality of processors included in the image processing unit 150 may be implemented separately from the sensor unit 130.

The tilting unit 160 may tilt at least one of a filter and a lens such that an optical path of light passing through at least one of the filter and the lens is repeatedly shifted according to a predetermined rule. To this end, the tilting unit 160 may include a tilting driver and a tilting actuator.

The lens may be a variable lens capable of changing an optical path. The variable lens may be a focus-variable lens. In addition, the variable lens may be a focus-adjustable lens. The variable lens may be at least one of a liquid lens, a polymer lens, a liquid crystal lens, a voice coil motor (VCM) type, and a shape memory (SMA) type. The liquid lens may include a liquid lens including one type of liquid and a liquid lens including two types of liquids. In the liquid lens including one type of liquid, a focus may be varied by adjusting a membrane disposed at a position corresponding to the liquid, and for example, the focus may be varied by pressing the membrane with an electromagnetic force of a magnet and a coil. The liquid lens including two types of liquids may include a conductive liquid and a non-conductive liquid, and an interface formed between the conductive liquid and the non-conductive liquid may be adjusted using a voltage applied to the liquid lens. In the polymer lens, a focus may be varied by controlling a polymer material through a piezo-driver or the like. In the liquid crystal lens, a focus may be varied by controlling a liquid crystal with an electromagnetic force. In the VCM type, a focus may be varied by controlling a solid lens or a lens assembly including a solid lens through an electromagnetic force between a magnet and a coil. In the SMA type, a focus may be varied by controlling a solid lens or a lens assembly including a solid lens using a shape memory alloy.

The tilting unit 160 may tilt at least one of the filter and the lens such that a path of light passing through the filter after tilting is shifted by a unit greater than zero pixels and less than one pixel of the sensor unit 130 with respect to a path of light passing through at least one of the filter and the lens before tilting. The tilting unit 160 may tilt at least one of the filter and the lens such that a path of light passing through at least one of the filter and the lens is shifted at least once from a preset reference path.

Hereinafter, each component of the camera module 100 according to the exemplary embodiment of the present invention shown in FIG. 1 will be described in detail with reference to the drawings.

FIG. 2 is a block diagram of a light-emitting unit according to one exemplary embodiment of the present invention.

As described above with reference to FIG. 1, a light-emitting unit 110 may refer to a component which generates an optical signal and then outputs the generated optical signal to an object. In order to implement such a function, the light-emitting unit 110 may include a light-emitting element 111, an optical element, a light modulator 112.

First, the light-emitting element 111 may refer to an element which receives electricity to generate light (ray). Light generated by the light-emitting element 111 may be infrared light having a wavelength of 770 nm to 3,000 nm. Alternatively, the light generated by the light-emitting element 111 may be visible light having a wavelength of 380 nm to 770 nm.

The light-emitting element 111 may include a light-emitting diode (LED). In addition, the light-emitting element 111 may include an organic light-emitting diode (OLED) or a laser diode (LD).

The light-emitting element 111 may be implemented in a form arranged according to a predetermined pattern. Accordingly, the light-emitting element 111 may be provided as a plurality of light-emitting elements. The plurality of light-emitting elements 111 may be arranged along rows and columns on a substrate. The plurality of light-emitting elements 111 may be mounted on the substrate. The substrate may be a printed circuit board (PCB) on which a circuit pattern is formed. The substrate may be implemented as a flexible printed circuit board (FPCB) in order to secure certain flexibility. In addition, the substrate may be implemented as any one of a resin-based PCB, a metal core PCB, a ceramic PCB, and an FR-4 board. Furthermore, the plurality of light-emitting elements 111 may be implemented in the form of a chip.

The light modulator 112 may control turn-on/off of the light-emitting element 111 and control the light-emitting element 111 to generate an optical signal in the form of a continuous wave or a pulse wave. The light modulator 112 may control the light-emitting element 111 to generate light in the form of a continuous wave or a pulse wave through frequency modulation, pulse modulation, or the like. For example, the light modulator 112 may repeat turn-on/off of the light-emitting element 111 at a certain time interval and control the light-emitting element 111 to generate light in the form of a pulse wave or a continuous wave. The certain time interval may be a frequency of an optical signal.

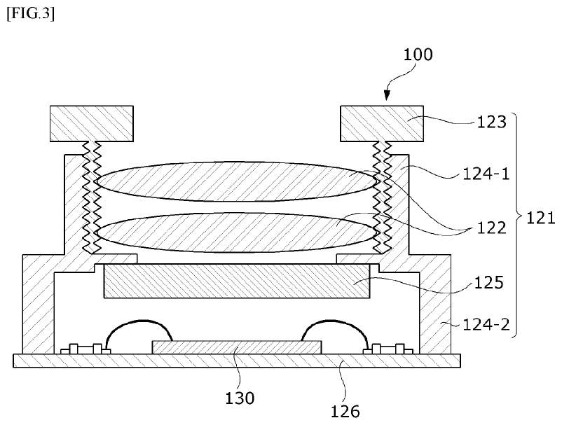

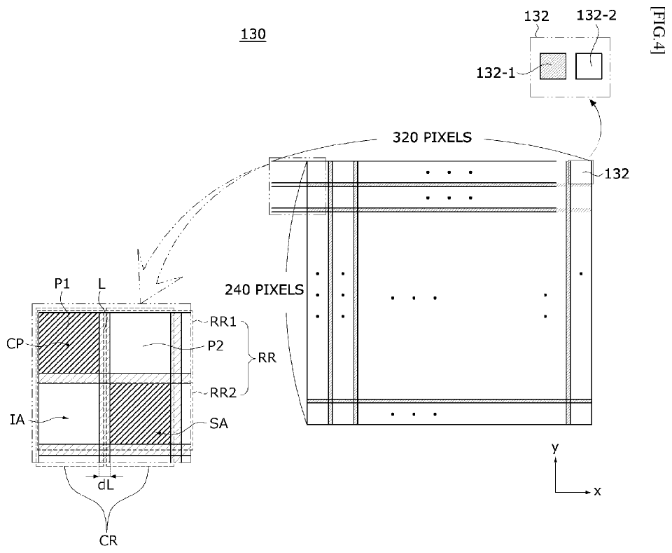

FIG. 3 is a diagram for describing a light-receiving unit according to an exemplary embodiment of the present invention.

Referring to FIG. 3, a light-receiving unit 120 includes a lens assembly 121 and a filter 125. The lens assembly 121 may include a lens 122, a lens barrel 123, and a lens holder 124.

The lens 122 may be provided as a plurality of lens or provided as one lens. The lens 122 may include the above-described variable lens. When the lens 122 is provided as the plurality of lenses, respective lenses may be arranged with respect to a central axis thereof to form an optical system. Here, the central axis may be the same as an optical axis of the optical system.

The lens barrel 123 is coupled to the lens holder 124, and a space for accommodating the lens may be formed therein. Although the lens barrel 123 may be rotatably coupled to the one lens or the plurality of lenses, this is merely an example, and the lens barrel 123 may be coupled through other methods such as a method using an adhesive (for example, an adhesive resin such as an epoxy).

The lens holder 124 may be coupled to the lens barrel 123 to support the lens barrel 123 and coupled to a PCB 126 on which a sensor 130 is mounted. Here, the sensor may correspond to the sensor unit 130 of FIG. 1. A space in which the filter 125 can be attached may be formed under the lens barrel 123 due to the lens holder 124. A spiral pattern may be formed on an inner circumferential surface of the lens holder 124, and the lens holder 124 may be rotatably coupled to the lens barrel 123 in which a spiral pattern is similarly formed on an outer circumferential surface thereof. However, this is merely an example, and the lens holder 124 and the lens barrel 123 may be coupled through an adhesive, or the lens holder 124 and the lens barrel 123 may be integrally formed.

The lens holder 124 may be divided into an upper holder 124-1 coupled to the lens barrel 123 and a lower holder 124-2 coupled to the PCB 126 on which the sensor 130 is mounted. The upper holder 124-1 and the lower holder 124-2 may be integrally formed, may be formed in separate structures and then connected or coupled, or may have structures that are separate and spaced apart from each other. In this case, a diameter of the upper holder 124-1 may be less than a diameter of the lower holder 124-2.

The filter 125 may be coupled to the lens holder 124. The filter 125 may be disposed between the lens assembly 121 and the sensor. The filter 125 may be disposed on a light path between an object and the sensor. The filter 125 may filter light having a predetermined wavelength range. The filter 125 may allow light having a specific wavelength to pass therethrough. That is, the filter 125 may reflect or absorb light other than light having a specific wavelength to block the light. The filter 125 may allow infrared light to pass therethrough and block light having a wavelength other than infrared light. Alternatively, the filter 125 may allow visible light to pass therethrough and block light having a wavelength other than visible light. The filter 125 may be moved. The filter 125 may be moved integrally with the lens holder 124. The filter 125 may be tilted. The filter 125 may be moved to adjust an optical path. The filter 125 may be moved to change a path of light incident to the sensor unit 130. The filter 125 may change an angle of a field of view (FOV) of incident light or a direction of the FOV.

Although not shown in FIG. 3, an image processing unit 150 may be implemented in the PCB. The light-emitting unit 110 of FIG. 1 may be disposed on a side surface of the sensor 130 on the PCB 126 or disposed outside a camera module 100, for example, on a side surface of the camera module 100.

The above example is merely one exemplary embodiment, and the light-receiving unit 120 may have another structure capable of condensing light incident to the camera module 100 and transmitting the light to the sensor.

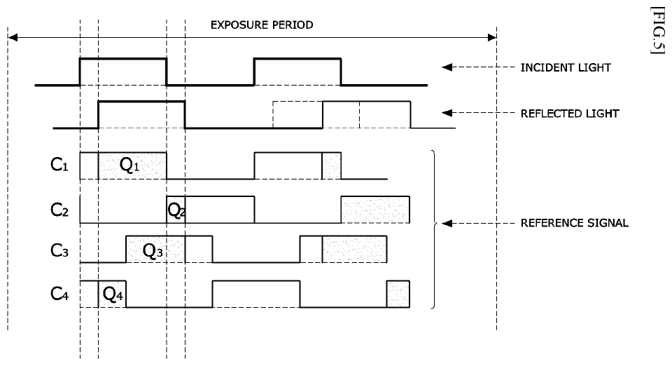

FIG. 4 shows diagrams for describing a sensor unit according to an exemplary embodiment of the present invention.

As shown in FIG. 4, in a sensor unit 130 according to the exemplary embodiment of the present invention, a plurality of cell areas P1, P2, . . . may be arranged in a grid form. For example, as shown in FIG. 4, in the sensor unit 130 having a resolution of 320×240, 76,800 cell areas may be arranged in a grid form.

A certain interval L may be formed between respective cell areas, and a wire for electrically connecting a plurality of cells may be disposed in the corresponding interval L. A width dL of the interval L may be very small as compared with a width of the cell area.

The cell areas P1, P2, . . . may refer to areas in which an input light signal is converted into electrical energy. That is, the cell areas P1, P2, . . . may refer to cell areas in which a photodiode configured to convert light into electrical energy is provided or may refer to cell areas in which the provided photodiode operates.

According to one exemplary embodiment, two photodiodes may be provided in each of the plurality of cell areas P1, P2, . . . . Each of the cell areas P1, P2, . . . may include a first light-receiving unit 132-1 including a first photodiode and a first transistor and a second light-receiving unit 132-2 including a second photodiode and a second transistor.

The first light-receiving unit 132-1 and the second light-receiving unit 132-2 may receive an optical signal with a phase difference of 180°. That is, when the first photodiode is turned on to absorb an optical signal and then turned off, the second photodiode is turned on to absorb an optical signal and then turned off The first light-receiving unit 132-1 may be referred to as an in-phase receiving unit, and the second light-receiving unit 132-2 may be referred to as an out-phase receiving unit. As described above, when the first light-receiving unit 132-1 and the second light-receiving unit 132-2 are activated with a time difference, a difference in amount of received light occurs according to a distance to an object. For example, when an object is right in front of a camera module 100 (that is, when a distance=zero), since a time taken for an optical signal to be output from a light-emitting unit 110 and then reflected from the object is zero, an on/off period of a light source may be a reception period of light without any change. Accordingly, only the first light-receiving unit 132-1 receives light, and the second light-receiving unit 132-2 does not receive light. As another example, when an object is positioned a predetermined distance away from the camera module 100, since it takes time for light to be output from the light-emitting unit 110 and then reflected from the object, an on/off period of the light source is different from a reception period of light. Accordingly, a difference occurs between an amount of light received by the first light-receiving unit 132-1 and an amount of light received by the second light-receiving unit 132-2. That is, a distance to an object may be calculated using a difference between an amount of light input to the first light-receiving unit 132-1 and an amount of light input to the second light-receiving unit 132-2.

FIG. 5 is a diagram for describing a process of generating an electrical signal according to an exemplary embodiment of the present invention.

As shown in FIG. 5, there may be reference signals, that is, four demodulated signals C1 to C4 according to an exemplary embodiment of the present invention. The demodulated signals C1 to C4 may have the same frequency as output light (light output from a light-emitting unit 110), that is, incident light from the point of view of an object, and may have a phase difference of 90°. One demodulated signal C1 of the four demodulated signals may have the same phase as the output light. A phase of input light (light received by a light-receiving unit 120), that is, reflected light from the point of view of the object, is delayed by as much as a distance by which the output light is reflected to return after being incident on the object. A sensor unit 130 mixes the input light and each demodulated signal. Then, the sensor unit 130 may generate an electrical signal corresponding to a shaded portion of FIG. 3 for each demodulated signal. The electrical signal generated for each demodulated signal may be transmitted to an image processing unit 150 as an image signal, or a digitally converted electrical signal may be transmitted to the image processing unit 150 as an image signal.

In another embodiment, when output light is generated at a plurality of frequencies during an exposure time, a sensor absorbs input light according to the plurality of frequencies. For example, it is assumed that output light is generated at frequencies f1 and f2, and a plurality of demodulated signals have a phase difference of 90°. Then, since incident light also has frequencies f1 and f2, four electrical signals may be generated through the input light having the frequency f1 and four demodulated signals corresponding thereto. In addition, four electrical signals may be generated through input light having the frequency f2 and four demodulated signals corresponding thereto. Accordingly, a total of eight electrical signals may be generated.

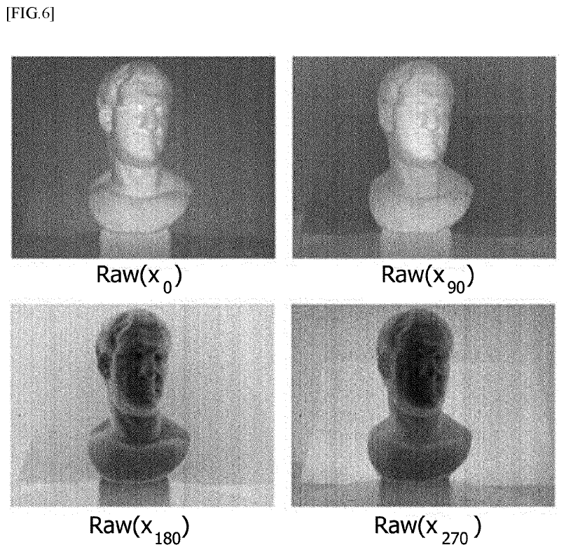

FIG. 6 is a diagram for describing a sub-frame image according to an exemplary embodiment of the present invention.

As described above, an electrical signal may be generated to correspond to a phase for each of four demodulated signals. Accordingly, as shown in FIG. 6, an image processing unit 150 may acquire sub-frame images corresponding to four phases. Here, the four phases may be 0°, 90°, 180°, and 270°, and the sub-frame image may be used interchangeably with a phase image, a phase infrared (IR) image, and the like.

In addition, the image processing unit 150 may generate a depth image based on the plurality of sub-frame images.

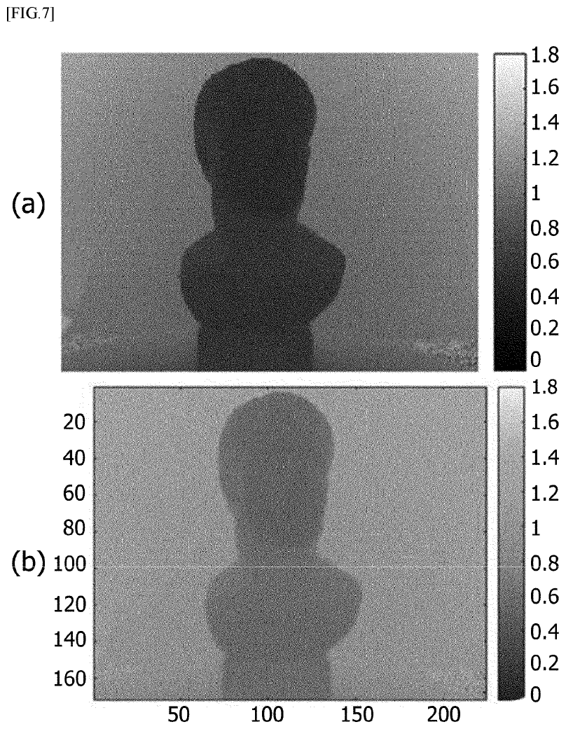

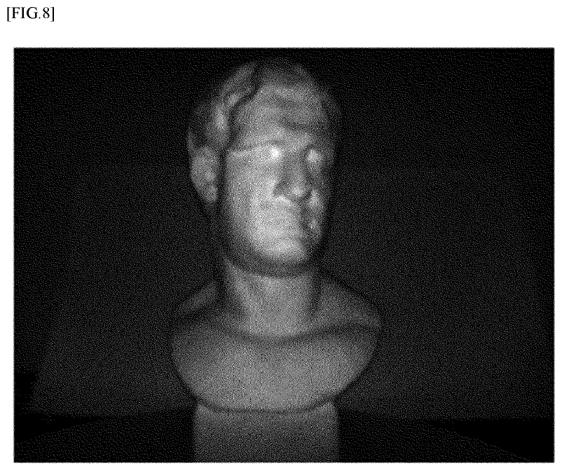

FIG. 7 is a diagram for describing a depth image according to an exemplary embodiment of the present invention.

The depth image of FIG. 7 represents an image generated based on the sub-frame images of FIG. 4. An image processing unit 150 may generate a depth image using a plurality of sub-frame images, and the depth image may be implemented through Equations 1 and 2 below.

$$Phase = arctan ( \frac{Raw ( {x}_{90} ) - Raw ( {x}_{270} )}{Raw ( {x}_{180} ) - Raw ( {x}_{0} )} ) \qquad [ Equation 1 ]$$

Here, Raw(x₀) denotes a sub-frame image corresponding to a phase of 0°. Raw(x₉₀) denotes a sub-frame image corresponding to a phase of 90°. Raw(x₁₈₀) denotes a sub-frame image corresponding to a phase of 180°. Raw(x₂₇₀) denotes a sub-frame image corresponding to a phase of 270°.

That is, the image processing unit 150 may calculate a phase difference between an optical signal output by a light-emitting unit 110 and an optical signal received by a light-receiving unit 120 for each pixel through Equation 1.

$$Depth = \frac{1}{2 f} c \frac{Ph ase}{2 π} ( c = speed of light ) \qquad [ Equation 2 ]$$

Here, f denotes a frequency of an optical signal. c denotes the speed of light.

That is, the image processing unit 150 may calculate a distance between a camera module 100 and an object for each pixel through Equation 2.

Meanwhile, the image processing unit 150 may also generate a ToF IR image based on the plurality of sub-frame images.

FIG. 8 is a diagram for describing a ToF IR image according to an exemplary embodiment of the present invention.

FIG. 8 shows an amplitude image which is a type of ToF IR image generated through four sub-frame images of FIG. 4.

In order to generate the amplitude image as shown in FIG. 8, an image processing unit 150 may use Equation 3 below.

$$Amplitude = \frac{1}{2} \sqrt{{( Raw ( {x}_{90} ) - Raw ( {x}_{270} ) )}^{2} + {( Raw ( {x}_{180} ) - Raw ( {x}_{0} ) )}^{2}} \qquad [ Equation 3 ]$$

As another example, the image processing unit 150 may generate an intensity image, which is a type of ToF IR image, using Equation 4 below. The intensity image may be used interchangeably with a confidence image.

$$Intensity = \vert Raw ( {x}_{90} ) - Raw ( {x}_{270} ) \vert + \vert Raw ( {x}_{180} ) - Raw ( {x}_{0} ) \vert \qquad [ Equation 4 ]$$

The ToF IR image such as the amplitude image or the intensity image may be a gray image.

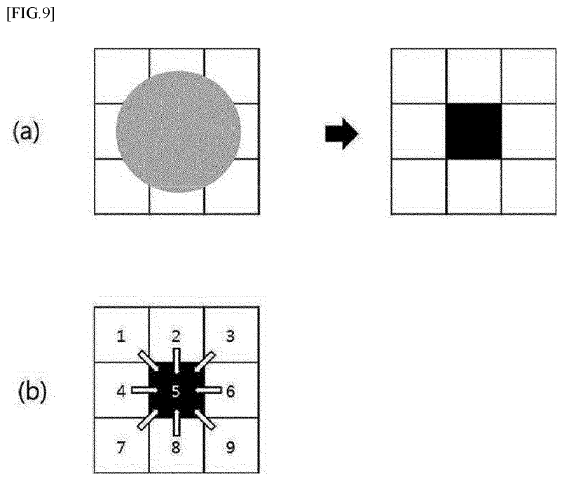

FIG. 9 shows diagrams for describing a first exemplary embodiment of the present invention.

According to the exemplary embodiment of the present invention, an image processing unit may generate a valid value of a second pixel based on a valid value of a first pixel among a plurality of pixels adjacent to the second pixel.

Specifically, when all pixels adjacent to the second pixel are the first pixels, the image processing unit may generate the valid value of the second pixel based on valid values of all the first pixels adjacent to the second pixel.

Hereinafter, detailed description will be provided through the exemplary embodiment of FIG. 9.

As shown in the left diagram of FIG. 9A, it is assumed that an optical signal reflected from an object is received at a light intensity greater than or equal to a certain value in an area corresponding to nine pixels. In this case, an optical signal having the light intensity greater than or equal to the certain value is received in an area corresponding to eight pixels so as to correspond to a partial area of each pixel, and an optical signal having the light intensity greater than or equal to the certain value is received in an area corresponding to one pixel so as to correspond to an entire area of the pixel.

In this case, when a corresponding image signal is generated and input to an image processing unit 150, the image processing unit may generate an image as shown in the right diagram of FIG. 9A. Here, a pixel which is not shaded represents a pixel having a valid value, and a pixel which is shaded represents a pixel having a null value, that is, an invalid value. That is, when an optical signal having the light intensity greater than or equal to the certain value is received over an entire area of a pixel, the corresponding pixel may not have a valid pixel value and may have a null value.

Referring to FIG. 9B, since pixels 1 to 4 and 6 to 9 are pixels having a valid value, pixels 1 to 4 and 6 to 9 may correspond to first pixels of the present invention. In addition, since pixel 5 has a null value and at least one of adjacent pixels (pixels 1 to 4 and 6 to 9) corresponds to the first pixel, pixel 5 may correspond to a second pixel of the present invention.

Since all pixels (pixels 1 to 4 and 6 to 9) adjacent to pixel 5 are the first pixels, the image processing unit 150 determines a valid value of pixel 5 based on pixels 1 to 4 and 6 to 9. For example, the image processing unit 150 may generate an average value of pixels 1 to 4 and 6 to 9 as the valid value of pixel 5. In addition, the image processing unit 150 may also generate the valid value of pixel 5 by applying the valid values of pixels 1 to 4 and 6 to 9 to an interpolation algorithm or a Gaussian profile algorithm.

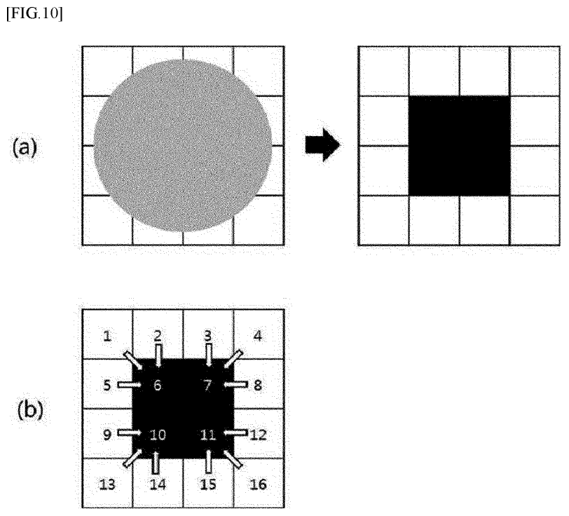

FIG. 10 shows diagrams for describing a second exemplary embodiment of the present invention.

When there are five first pixels adjacent to a second pixel, an image processing unit 150 may generate a valid value of the second pixel based on valid values of three first pixels among the five first pixels. Here, the three first pixels among the five first pixels may include two first pixels adjacent to one surface of the second pixel and one first pixel disposed between the two first pixels adjacent to one surface of the second pixel.

Hereinafter, detailed description will be provided through the exemplary embodiment of FIG. 10.

As shown in the left diagram of FIG. 10A, it is assumed that an optical signal reflected from an object is received at a light intensity greater than or equal to a certain value in an area corresponding to sixteen pixels. In this case, an optical signal having the light intensity greater than or equal to the certain value is received in an area corresponding to twelve pixels so as to correspond to a partial area of each pixel, and an optical signal having the light intensity greater than or equal to the certain value is received in an area corresponding to four pixels so as to correspond to an entire area of each pixel.

In this case, when a corresponding image signal is generated and input to an image processing unit 150, the image processing unit may generate an image as shown in the right diagram of FIG. 10A. Here, a pixel which is not shaded represents a pixel having a valid value, and a pixel which is shaded represents a pixel having a null value, that is, an invalid value. That is, when an optical signal having the light intensity greater than or equal to the certain value is received over an entire area of a pixel, the corresponding pixel may not have a valid pixel value and may have a null value.

Referring to FIG. 10B, since pixels 1 to 5, 8, 9, and 12 to 16 are pixels having a valid value, and pixels 1 to 5, 8, 9, and 12 to 16 may correspond to first pixels of the present invention. In addition, since pixels 6, 7, 10, and 11 have a null value and at least one of pixels adjacent to each of pixels 6, 7, 10, and 11 is a pixel corresponding to the first pixel, pixels 6, 7, 10, and 11 may correspond to second pixels of the present invention. Whether a pixel corresponds to the second pixel in

FIG. 10 is summarized in Table 1 below.

TABLE 1

| | | | | Whether pixel |
|---|---|---|---|---|
| | | | First pixels among | corresponds |
| | Pixel value | Adjacent pixels | adjacent pixels | to second pixel |
| Pixel 6 | Null | 1, 2, 3, 5, 7, 9, 10, 11 | 1, 2, 3, 5, 9 | Corresponding |
| Pixel 7 | Null | 2, 3, 4, 6, 8, 10, 11, 12 | 2, 3, 4, 8, 12 | Corresponding |
| Pixel 10 | Null | 5, 6, 7, 9, 11, 13, 14, 15 | 5, 9, 13, 14, 15 | Corresponding |
| Pixel 11 | Null | 6, 7, 8, 10, 12, 14, 15, 16 | 8, 12, 14, 15, 16 | Corresponding |

Among pixels adjacent to pixel 6, five pixels 1, 2, 3, 5, and 9 are the first pixels. The image processing unit 150 may generate a valid value of pixel 6, which is the second pixel, using three first pixels among the five first pixels. Here, the three first pixels include pixels 2 and 5 adjacent to one surface of pixel 6 and pixel 1 disposed between pixel 2 and pixel 5. That is, the image processing unit 150 may generate a valid value of pixel 6 based on pixels 1, 2, and 5. Among pixels adjacent to pixel 7, five pixels 2, 3, 4, 8, and 12 are the first pixels. The image processing unit 150 may generate a valid value of pixel 7, which is the second pixel, using three first pixels among the five first pixels. Here, the three first pixels include pixels 3 and 8 adjacent to one surface of the pixel 7 and pixel 4 disposed between pixel 3 and pixel 8. That is, the image processing unit 150 may generate the valid value of pixel 7 based on pixels 1, 4, and 8.

Among pixels adjacent to pixel 10, five pixels 5, 9, 13, 14, and 15 are the first pixels. The image processing unit 150 may generate a valid value of pixel 10, which is the second pixel, using three first pixels among the five first pixels. Here, the three first pixels include pixels 9 and 14 adjacent to one surface of pixel 10 and pixel 13 disposed between pixel 9 and pixel 14. That is, the image processing unit 150 may generate the valid value of pixel 10 based on pixels 9, 13, and 14.

Among pixels adjacent to pixel 11, five pixels 8, 12, 14, 15, and 16 are the first pixels. The image processing unit 150 may generate a valid value of pixel 11, which is the second pixel, using three first pixels among the five first pixels. Here, the three first pixels include pixels 12 and 15 adjacent to one surface of pixel 11 and pixel 16 disposed between pixel 12 and pixel 15. That is, the image processing unit 150 may generate the valid value of pixel 11 based on pixels 12, 15, and 16.

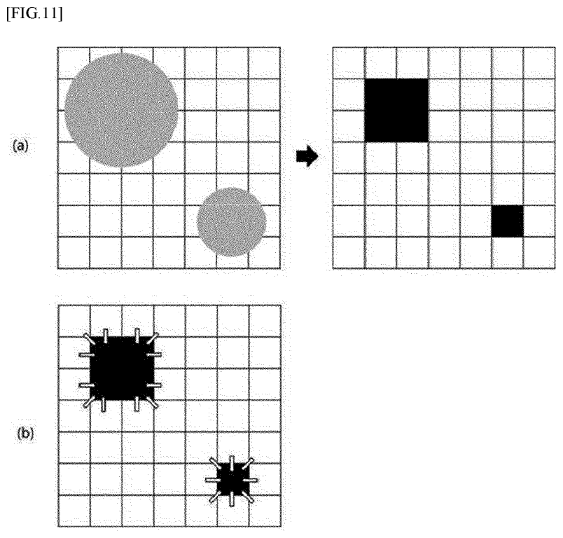

FIG. 11 shows diagrams illustrating one exemplary embodiment of the present invention.

In FIG. 11A, the exemplary embodiments of FIGS. 9 and 10 are illustrated together in one image. As shown in FIG. 11, second pixels may be present in a plurality of areas. For example, when five second pixels are included in an image as shown in FIG. 11B, an image processing unit 150 may generate valid values of the five second pixels as shown in FIG. 11B.

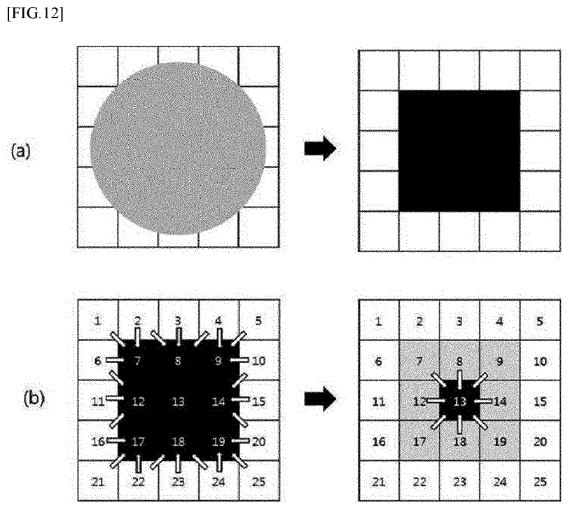

FIG. 12 shows diagrams for describing a third exemplary embodiment of the present invention.

FIG. 12 illustrates a case in which first to third pixels are included. The third pixel may have a null value, but all pixels adjacent thereto may have a null value. That is, the pixel adjacent to the third pixel may be the second pixel or another third pixel. However, the pixel adjacent to the third pixel may not be the first pixel.

When a valid value of at least one pixel of the pixels adjacent to the third pixel is generated, an image processing unit 150 may generate a valid value of the third pixel based on the generated valid value of the pixel adjacent to the third pixel. That is, the valid value of the third pixel may be generated after a valid value of the second pixel is generated.

Hereinafter, detailed description will be provided through the exemplary embodiment of FIG. 12.

As shown in the left diagram of FIG. 12A, it is assumed that an optical signal reflected from an object is received at a light intensity greater than or equal to a certain value in an area corresponding to 25 pixels. In this case, an optical signal having the light intensity greater than or equal to the certain value is received in an area corresponding to sixteen pixels so as to correspond to a partial area of each pixel, and an optical signal having the light intensity greater than or equal to the certain value is received in an area corresponding to nine pixels so as to correspond to an entire area of each pixel.

In this case, when a corresponding image signal is generated and input to the image processing unit 150, the image processing unit may generate an image as shown in the right diagram of FIG. 12A. Here, a pixel which is not shaded represents a pixel having a valid value, and a pixel which is shaded represents a pixel having a null value, that is, an invalid value. That is, when an optical signal having the light intensity greater than or equal to the certain value is received over an entire area of a pixel, the corresponding pixel may not have a valid pixel value and may have a null value.

Referring to FIG. 12B, since pixels 1 to 6, 10, 11, 15, 16, and 20 to 25 are pixels having a valid value, pixels 1 to 6, 10, 11, 15, 16, and 20 to 25 may correspond to the first pixels of the present invention. In addition, pixels 7 to 12, 14, and 17 to 19 have a null value and at least one of pixels adjacent to each of pixels 7 to 12, 14, and 17 to 19 corresponds to the first pixel, pixels 7 to 12, 14, and 17 to 19 may correspond to the second pixels of the present invention. In addition, since pixel 13 is a pixel in which all pixels adjacent thereto have a null value, pixel 13 may correspond to the third pixel of the present invention. Whether a pixel corresponds to the second pixel and the third pixel in FIG. 12 is summarized in Table 2 below.

TABLE 2

| | | | First pixels among | |
|---|---|---|---|---|
| | Pixel value | Adjacent pixels | adjacent pixels | Type of pixel |
| Pixel 7 | Null | 1, 2, 3, 6, 8, 11, 12, 13 | 1, 2, 3, 6, 11 | Second pixel |
| Pixel 8 | Null | 2, 3, 4, 7, 9, 12, 13, 14 | 2, 3, 4 | Second pixel |
| Pixel 9 | Null | 3, 4, 5, 8, 10, 13, 14, 15 | 3, 4, 5, 10, 15 | Second pixel |
| Pixel 12 | Null | 6, 7, 8, 11, 13, 16, 17, 18 | 6, 11, 16 | Second pixel |
| Pixel 13 | Null | 7, 8, 9, 12, 14, 17, 18, 19 | None | Third pixel |
| Pixel 14 | Null | 8, 9, 10, 13, 15, 18, 19, 20 | 10, 15, 20 | Second pixel |
| Pixel 17 | Null | 11, 12, 13, 16, 18, 21, 22, 23 | 11, 16, 21, 22, 23 | Second pixel |
| Pixel 18 | Null | 12, 13, 14, 17, 19, 22, 23, 24 | 22, 23, 24 | Second pixel |
| Pixel 19 | Null | 13, 14, 15, 18, 20, 23, 24, 25 | 15, 20, 23, 24, 25 | Second pixel |

According to the exemplary embodiment of the present invention, first, as shown in the left diagram of FIG. 12B, the image processing unit 150 may calculate valid values of pixels 7 to 12, 14, and 17 to 19 which are the second pixels (first step). Among pixels adjacent to pixel 7, five pixels 1, 2, 3, 6, and 11 are the first pixels. The image processing unit 150 may generate a valid value of pixel 7, which is the second pixel, using three first pixels among the five first pixels. Here, the three first pixels include pixels 2 and 6 adjacent to one surface of pixel 7 and pixel 1 disposed between pixel 2 and pixel 6. That is, the image processing unit 150 may generate the valid value of pixel 7 based on pixels 1, 2, and 6.

Among pixels adjacent to pixel 8, three pixels 2, 3, and 4 are the first pixels. As described above, when there are three first pixels adjacent to the second pixel, the image processing unit 150 may generate a valid value of the second pixel based on valid values of the three first pixels. Accordingly, the image processing unit 150 may generate a valid value of pixel 8 based on pixels 2, 3, and 4.

Among pixels adjacent to pixel 9, five pixels 3, 4, 5, 10, and 15 are the first pixels. The image processing unit 150 may generate a valid value of pixel 9, which is the second pixel, using three first pixels among the five first pixels. Here, the three first pixels include pixels 4 and 10 adjacent to one surface of pixel 9 and pixel 5 disposed between pixel 9 and pixel 14. That is, the image processing unit 150 may generate the valid value of pixel 9 based on pixels 4, 5, and 10.

Among pixels adjacent to pixel 12, three pixels 6, 11, and 16 are the first pixels. Accordingly, the image processing unit 150 may generate a valid value of pixel 8 based on pixels 6, 11, and 16.

Among pixels adjacent to pixel 14, three pixels 10, 15, and 20 are the first pixels. Accordingly, the image processing unit 150 may generate a valid value of pixel 14 based on pixels 10, 15, and 20.

Among pixels adjacent to pixel 17, five pixels 11, 16, 21, 22, and 23 are the first pixels. The image processing unit 150 may generate a valid value of pixel 17, which is the second pixel, using three first pixels among the five first pixels. Here, the three first pixels include pixels 16 and 22 adjacent to one surface of pixel 17 and pixel 21 disposed between pixel 16 and pixel 22. That is, the image processing unit 150 may generate the valid value of pixel 17 based on pixels 16, 21, and 22.

Among pixels adjacent to pixel 18, three pixels 22, 23, and 24 are the first pixels. Accordingly, the image processing unit 150 may generate a valid value of pixel 18 based on pixels 22, 23, and 24.

Among pixels adjacent to pixel 19, five pixels 15, 20, 23, 24, and 25 are the first pixels. The image processing unit 150 may generate a valid value of pixel 19, which is the second pixel, using three first pixels among the five first pixels. Here, the three first pixels include pixels 20 and 24 adjacent to one surface of pixel 19 and pixel 25 disposed between pixel 20 and pixel 24. That is, the image processing unit 150 may generate the valid value of pixel 19 based on pixels 20, 24, and 25.

After the valid values for pixels 7 to 12, 14, and 17 to 19, which are the second pixels, are generated, the image processing unit 150 may calculate a valid value of pixel 13 which is the third pixel based on the valid values of pixels 7 to 12, 14, and 17 to 19. In this case, the image processing unit 150 may generate a valid value of the third pixel using a rule for generating a valid value of the second pixel.

In addition, as shown in the right diagram of FIG. 12B, the image processing unit 150 may generate the valid value of the third pixel based on a valid value of a pixel adjacent to the third pixel (step 2).

When the valid value of the third pixel is calculated, the image processing unit 150 may use a method of generating the valid value of the second pixel using a valid value of the first pixel.

In FIG. 12B, since all pixels adjacent to pixel 13, which is the third pixel, have generated valid values, the image processing unit 150 generates a valid value of pixel 13 based on the generated valid values of pixels 7 to 12, 14, and 17 to 19.

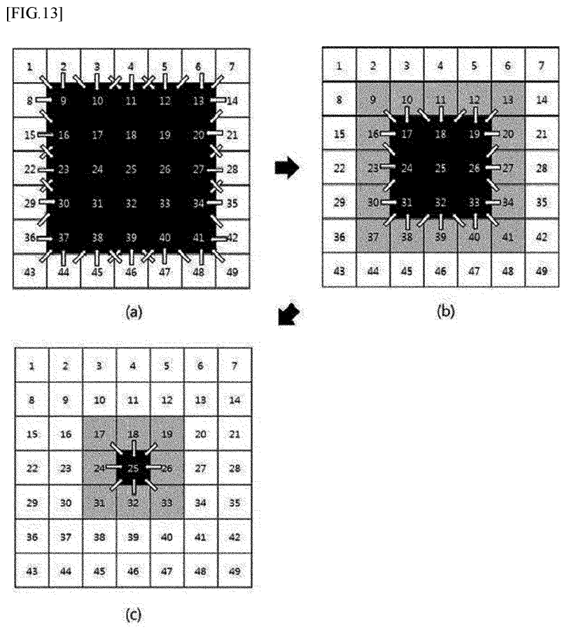

FIG. 13 shows one exemplary embodiment of the present invention.

In FIG. 13, pixels 1 to 8, 14, 15, 21, 22, 28, 29, 35, 36, and 42 to 29 are first pixels. Pixels 9 to 13, 16, 20, 23, 27, 30, 34, and 37 to 41 are second pixels. Pixels 17 to 19, 24, 26, and 31 to 33 are third pixels.

In a first step (see FIG. 13A), an image processing unit 150 may generate valid values of pixels 9 to 13, 16, 20, 23, 27, 30, 34, and 37 to 41 which are the second pixels. As shown in Table 3 below, the image processing unit 150 may generate a valid value of the second pixel using valid values of pixels adjacent to the second pixel.

TABLE 3

| Number of | First pixels among | Pixels used to generate |
|---|---|---|
| second pixel | adjacent pixels | valid value |
| Pixel 9 | 1, 2, 3, 8, 15 | 1, 2, 8 |
| Pixel 10 | 2, 3, 4 | 2, 3, 4 |
| Pixel 11 | 3, 4, 5 | 3, 4, 5 |
| Pixel 12 | 4, 5, 6 | 4, 5, 6 |
| Pixel 13 | 5, 6, 7, 14, 21 | 6, 7, 14 |
| Pixel 16 | 8, 15, 22 | 8, 15, 22 |
| Pixel 20 | 14, 21, 28 | 14, 21, 28 |
| Pixel 23 | 15, 22, 29 | 15, 22, 29 |
| Pixel 27 | 21, 28, 35 | 21, 28, 35 |
| Pixel 30 | 22, 29, 36 | 22, 29, 36 |
| Pixel 34 | 28, 35, 42 | 28, 35, 42 |
| Pixel 37 | 29, 36, 43, 44, 45 | 36, 43, 44 |
| Pixel 38 | 44, 45, 46 | 44, 45, 46 |
| Pixel 39 | 45, 46, 47 | 45, 46, 47 |
| Pixel 40 | 46, 47, 48 | 46, 47, 48 |
| Pixel 41 | 35, 42, 47, 48, 49 | 42, 48, 49 |

In a second step (see FIG. 13B), the image processing unit 150 may generate valid values of pixels 17 to 19, 24, 26, and 31 to 33 which are the third pixels. As shown in Table 4 below, the image processing unit 150 may generate a valid value of the second pixel using valid values of pixels adjacent to the third pixel. In this case, the valid value of the adjacent pixel is a valid value generated by the image processing unit 150.

TABLE 4

| Number of | Pixels having valid value | Pixels used to generate |
|---|---|---|
| third pixel | among adjacent pixels | valid value |
| Pixel 17 | 9, 10, 11, 16, 23 | 9, 10, 16 |
| Pixel 18 | 10, 11, 12 | 10, 11, 12 |
| Pixel 19 | 11, 12, 13, 20, 27 | 12, 13, 20 |
| Pixel 24 | 16, 23, 30 | 16, 23, 30 |
| Pixel 26 | 20, 27, 34 | 20, 27, 34 |
| Pixel 31 | 23, 30, 37, 38, 39 | 30, 37, 38 |
| Pixel 32 | 38, 39, 40 | 38, 39, 40 |
| Pixel 33 | 27, 34, 39, 40, 41 | 34, 40, 41 |

In a third step (see FIG. 13C), the image processing unit 150 may generate a valid value of pixel 25 which is the third pixel. All pixels adjacent to pixel 25 are the third pixels, and thus, there is no valid value generated in the second step. Accordingly, the valid value of pixel 25 may be generated in the third step after valid values of pixels adjacent thereto are generated in the second step. Since valid values of all pixels adjacent to pixel 25 are generated in the third step, the image processing unit 150 may generate the valid value of pixel 25 based on the generated valid values for pixels 17 to 19, 24, 26, and 31 to 33. The present invention has been described based on the exemplary embodiments, but the exemplary embodiments are for illustrative purposes and do not limit the present invention, and those skilled in the art will appreciate that various modifications and applications, which are not exemplified in the above description, may be made without departing from the scope of the essential characteristic of the present exemplary embodiments. For example, each component described in detail in the exemplary embodiment can be modified. Further, the differences related to the modification and the application should be construed as being included in the scope of the present invention defined in the appended claims.

1. A camera module comprising:
a light-emitting unit configured to output an optical signal to an object;
a light-receiving unit configured to receive the optical signal that is output from the light-emitting unit and reflected from the object;
a sensor unit configured to receive the optical signal received by the light-receiving unit through a plurality of pixels; and
an image processing unit configured to process information, which is received through first pixels having valid values and second pixels having invalid values, using the optical signal, wherein the invalid value is a value in which the pixel is saturated,
wherein at least one of the plurality of pixels adjacent to the second pixel includes the first pixel, and
the image processing unit generates a valid value of the second pixel based on the valid value of the first pixel among the plurality of pixels adjacent to the second pixel.

2. The camera module of claim 1, wherein, when all of the pixels adjacent to the second pixel are the first pixels, the image processing unit generates the valid value of the second pixel based on the valid values of all of the first pixels adjacent to the second pixel.

3. The camera module of claim 1, wherein, when there are five first pixels adjacent to the second pixel, the image processing unit generates the valid value of the second pixel based on the valid values of three first pixels among the five first pixels.

4. The camera module of claim 3, wherein, among the five first pixels, the three first pixels include two first pixels adjacent to one surface of the second pixel and one first pixel disposed between the two first pixels adjacent to the one surface of the second pixel.

5. The camera module of claim 3, wherein, when there are three first pixels adjacent to the second pixel, the image processing unit generates the valid value of the second pixel based on the valid values of the three first pixels.

6. The camera module of claim 1, wherein the image processing unit generates the valid value of the second pixel by performing an interpolation technique, an average technique, or a Gaussian profile technique on at least one of the valid values of the first pixels adjacent to the second pixel.

7. The camera module of claim 1, wherein an image further includes third pixels having invalid values, wherein all of the pixels adjacent to the third pixel have invalid values.

8. The camera module of claim 7, wherein, when a valid value of at least one pixel among the pixels adjacent to the third pixel is generated, the image processing unit generates a valid value of the third pixel based on the generated valid value of the pixel adjacent to the third pixel.

9. The camera module of claim 8, wherein the image processing unit generates the valid value of the third pixel based on the valid values of all of the second pixels adjacent to the third pixel.

10. The camera module of claim 9, wherein the image processing unit generates the valid value of the third pixel by applying at least one of an interpolation technique, an average technique, and a Gaussian profile technique.
